(19) United States
(12) Patent Application Publication
(10) Pub. No.: US 2022/0163323 A1
(43) Pub. Date: May 26, 2022

(54) Irradiance-Based Radiation Source Orientation Method

(71) Applicants: Shoude WANG, Guiyang (CN); Chengdu University of Information Technology, Chengdu, Sichuan Province (CN)

(72) Inventors: Jiang WANG, Chengdu (CN); Juan WU, Chengdu (CN); Jianxin HE, Chengdu (CN); Yuming DU, Chengdu (CN); Xinggang ZHANG, Chengdu (CN); Shoude WANG, Guiyang (CN)

(21) Appl. No.: 17/441,963

(22) PCT Filed: Mar. 18, 2020
(86) PCT No.: PCT/CN2020/079981

§ 371 Date: Sep. 22, 2021

(30) Foreign Application Priority Data
Mar. 22, 2019 (CN) 201910223070.6

(51) Int. Cl. G01B 11/26

(52) U.S. Cl. CPC G01B 11/26

(57) ABSTRACT

The present invention relates to the technical field of orientation of radiation sources. The present invention discloses a method for orientating a radiation source based on irradiance. The method is characterized by comprising the following steps: accepting irradiation of the radiation source on M side surfaces of a regular pyramid or a regular prismoid and measuring irradiance of the M side surfaces; sequencing the irradiance of the M side surfaces to obtain an orientation sequence; performing Fourier transform on the orientation sequence to obtain a coefficient of each of frequency spectrum component Fourier series; and obtaining an azimuth angle αₛ and an elevating angle γ of the radiation source according to a frequency spectrum component of the orientation sequence with an angular frequency of 0 and ±2π/M, wherein M is an integer and is greater than or equal to 3; and in the M side surfaces, unit normal vector azimuth angles of adjacent side surfaces differ from each other at an integer multiple of 2π/M. The orientation method of the present invention may be used for orientation of the sun, orientation of a microwave source and orientation of various radioactive radiation sources.

### FIELD OF TECHNOLOGY

The present invention relates to the technical field of orientation of radiation sources, in particular to a method for orientating a radiation source based on irradiance.

### BACKGROUND

A radiation source passive orientation technique has important position and function in military and civilian application fields of navigation, aerospace, electronic warfare and so on. Existing research emphasis is focused on two aspects: spatial spectrum estimation and optical imaging in array signal processing. In spatial spectrum estimation, a radio signal source in a distance field is oriented according to characteristics of frequency, amplitude and phase of the radiation source, and a detection object is limited to radio. In optical imaging, an optical radiation source is oriented according to optical characteristics of the radiation source, and a detection object is limited to the optical radiation source. Theoretically, spatial spectrum estimation has a huge advantage in estimating a spatial signal source angle and related variables in a system processing bandwidth in precision, and has a wide prospect in the fields of radar, mobile communication, sonar and so on. There are still defects in solutions for problems in estimation of number of signal sources, decoherence of the signal sources, consistency of transmission characteristics of an array element channel, and there are still many problems in practical application. In addition, the orientation of a broadband signal source can be realized by decomposing the broadband signal source into several narrowband signal sources in spatial spectrum estimation However it is required by these methods that the number of array elements is greater than that of the signal sources, and thus, the orientation bandwidth thereof is limited to the number of array elements. The orientation technique of optical imaging has been widely applied to many fields as a result of high precision, for example, satellite attitude control in aerospace or solar angle measurement in auxiliary positioning of aerospace landing devices, and early warning and so on are realized by passive orientation of the optical radiation sources such as laser on the ground or in the air in military. In recent years, many optical radiation source orientation methods with large visual fields and high precision have emerged, in particular, in the field of aerospace, for example, a solar orientation method based on image sensors such as a CMOS APS area array and other solar orientation methods by using a vernier caliper and so on. However, as limited by implementation principles, which requires a distance between an array detector and an incident hole of a light source greater than 0 or a distance between the detector and a slit greater than 0, the detection visual fields of these methods are smaller than 180 degrees Aiming at defects in spatial spectrum estimation and optical imaging orientation techniques, some literatures provide a novel technique of orientating a whole visual field of a spherical surface of a radiation source by using array element radiation energy. Compared with spatial spectrum estimation and optical imaging orientation technique, it realizes orientation by a basic characteristic radiation energy of the radiation source, and theoretically, passive orientation of all the radiation sources is met. Therefore, it has a huge advantage in application range. Meanwhile, as its orientation merely requires that a ratio of the radiation energy output by the array element detector to energy radiated by the radiation source on the array element detection surface is a same constant and it is further relatively easy to measure the radiation energy, it further has an advantage in system implementation. However, in existing researches, the radiation source is usually oriented by means of radiation energy detected and output by direct radiation element arrays. Limited by the implementation methods, they do not have anti-noise performance, which means that the orientation precision in actual application is easily interfered by noise, and the orientation precision on the ground under the sun on a sunny day is usually 4.4 degrees. As far as orientation application in a noise environment is concerned, the technique is still short of an effective anti-interference method.

### SUMMARY

It is thereof a primary objective of the present invention to provide a method for orientating a radiation source based on irradiance, thereby further improving the positioning precision of the radiation source.

In order to achieve the objective, according to an aspect of a specific implementation mode of the present invention, a method for orientating a radiation source based on irradiance is provided, the method including the following steps:

accepting irradiation of the radiation source on M side surfaces of a regular pyramid or a regular prismoid (which is a truncated regular pyramid) and measuring irradiance of the M side surfaces;

sequencing the irradiance of the M side surfaces to obtain an orientation sequence;

performing Fourier transform on the orientation sequence to obtain a coefficient of each of frequency spectrum component Fourier series; and

obtaining an azimuth angle αₛ and an elevating angle γ of the radiation source according to a frequency spectrum component of the orientation sequence with an angular frequency of 0 and [symbol] ,

wherein M is an integer and [symbol] ; and in the M side surfaces, unit normal vector azimuth angles of adjacent side surfaces differ from each other at an integer multiple of [symbol] .

In some embodiments, the radiation source is a light source.

In some embodiments, the radiation source is the sun.

In some embodiments, the radiation source is a voltage or a current output by a photoelectric sensor.

In some embodiments, the radiation source is a microwave emission source.

In some embodiments, the radiation source is a voltage or a current output by a Hall sensor.

In some embodiments, a method of sequencing the irradiance of the M side surfaces to obtain an orientation sequence specifically includes:

sequencing the irradiance of the M side surfaces to obtain the orientation sequence according to a dimension of an azimuth angle αᵢ of each of unit normal vectors nᵢ of the M side surfaces,

wherein nᵢ is the unit normal vector of the ith side surface, αᵢ is the azimuth angle of nᵢ, and is equal to 0, 1, to (M−1).

In some embodiments, the minimum angular frequency is [symbol] or [symbol] .

In some embodiments, an expression αₛ of the azimuth angle is

[symbol] , wherein is the azimuth angle of the unit normal vector n₀, and X( [symbol] ) is a frequency spectrum component of the orientation sequence at the minimum angular frequency [symbol] and [symbol] ;

an expression formula of the elevating angle γ is as follows:

$$γ = arctan \frac{\text{?}}{\text{?}} ( \vert X ( \text{?} ) \vert / \vert X ( \text{?} ) \vert ) , \\ \text{?} \text{indicates text missing or illegible when filed}$$

wherein [symbol] is the frequency spectrum component of the orientation sequence at the angular frequency of 0.

The present invention has the beneficial effects that the method is easy to implement and the orientation precision of the radiation source can be improved.

Further description of the present invention will be made below in combination with drawings and specific implementation modes. Additional aspects and advantages of the present invention will be given partially in the description below, and a part of the additional aspects and advantages will become obvious in the description below or can be understood via practice of the present invention.

### BRIEF DESCRIPTION OF THE DRAWINGS

The drawings constituting a part of the disclosure are to provide further understanding of the present invention. The specific implementation modes, schematic embodiments and description thereof are used for explaining the present invention and do not limit the present invention improperly. In the drawings,

FIG. 1 is a schematic diagram of a geometrical relationship of a vector of a radiation source and a sensor mounting plane on a regular pyramid.

### DETAILED DESCRIPTION OF THE EMBODIMENTS

It is to be noted that in the absence of conflict, the specific implementation modes, the embodiments of the present disclosure and features in the embodiments can be combined with one another. Detailed description on the present invention will be made below in combination with the following contents with reference to drawings.

In order to make those skilled in the art better understand the scheme of the present disclosure, clear and intact description will be made on technical schemes in the specific implementation mode and the embodiments of the present invention below in combination with drawings in the embodiment of the present invention. The described embodiments are merely a part of embodiments of the present invention and are not all the embodiments. On a basis of the specific implementation modes and embodiments in the present invention, all other implementation modes and embodiments obtained by those skilled in the technical field without creative efforts shall fall into the scope of protection of the present invention.

Assuming that a ray of the radiation source arriving at an observation point is parallel or a distance from the radiation source to the observation point is far enough, the ray of the radiation source arriving at the observation point may approximately be parallel, for example, sunlight irradiated to the ground. In order to describe a spatial direction of the radiation source and the radiation energy when it arrives at the observation point, we construct a vector directed to the radiation source, a module of which is equal to irradiance (radiation flux in a unit area on a surface of a radiated object) at which the radiation source is incident to the plane vertically. It is defined as a vector of the radiation source. In addition, in order to describe a direction of the vector on a space rectangular coordinate system, we define two angles for the vectors: azimuth angle and elevating angle. The azimuth angle of the vector is the angle from true north (if applied on the Earth), noted here again as the positive y direction, which rotates to the east to a projection of the vector on the x-y plane, and the elevating angle of the vector is an included angle between the vector and the x-y coordinate surface.

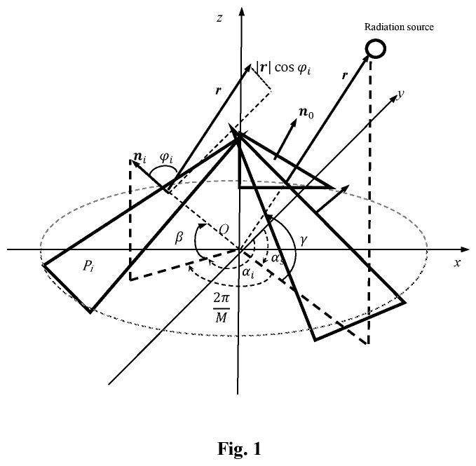

By taking a bottom surface of the regular pyramid as the x-y coordinate plane and a center of a bottom surface thereof as an origin, an x-y-z space rectangular coordinate system is established. It is assumed that side surfaces of the regular pyramid may be irradiated by the radiation source. M sensors (M is greater than or equal to 3) are mounted on these side surfaces to detect the irradiance of the radiation source irradiated to the sensor mounting plane. When the number of the side surfaces of the regular pyramid is smaller than the number of the sensors mounted on the side surfaces of the regular pyramid, a plurality of sensors will detect the irradiance of a same side surface. A geometrical relationship of a vector of a radiation source and a sensor mounting plane is as shown in FIG. 1. In FIG. 1, the sensors are successively numbered from 0 to M−1 in light of amplitudes of the azimuth angles of unit normal vectors of the mounting plane according to an ascending sequence. When two sensors are mounted on a same plane, it is assumed that the azimuth angles of unit normal vectors of their mounting plane are α, and the azimuth angles of the two sensor mounting planes are distributed as α and [symbol] . When the number of sensors mounted on the same plane is greater than 3, we distribute the azimuth angles of the sensor mounting planes according to the method. The azimuth angle of the vector r of the radiation source is αₛ, and the elevating angle is γ; the unit normal vector of the mounting side surface of the sensor [symbol] , the azimuth angle and the elevating angle of nᵢ are respectively αᵢ and β; and the included angle between the vector r of the radiation source and the unit normal vector nᵢ is φᵢ.

According to cosine law of radiation: the irradiance of any one surface changes along with cosine of the included angle between a radiation energy propagation direction and a normal of the plane, it can be obtained from the geometrical relationship shown in FIG. 1 that the irradiance of the radiation source irradiated to the mounting plane of the sensor Pᵢ is [symbol] is just equal to an inner product of the vector r of the radiation source and the unit normal vector nᵢ, that is, [symbol] . Therefore, the irradiance xᵢ of the radiation source irradiated to the mounting plane of the sensor Pᵢ is represent as

$$\text{?} = \vert r \vert cos φ \text{?} . \\ \text{?} \text{indicates text missing or illegible when filed} \qquad ( 1 )$$

Further, [symbol] is put into an equation (1) to obtain

$$\text{?} = n \text{?} r , \\ \text{?} \text{indicates text missing or illegible when filed} \qquad ( 2 )$$

wherein [symbol] and [symbol] may be inferred according to the geometrical relationship shown in FIG. 1.

For light sources such as the sun, the irradiance xᵢ may be the photoelectric sensor such as a voltage or a current output by a solar battery, a photodiode and the like. For the microwave emission source, the irradiance xᵢ may be an electromagnetic receiver such as a voltage or a current output by a Hall sensor and the like.

It is assumed that the azimuth angles of the unit normal vectors of the sensor mounting planes adjacent in number differ [symbol] . For example, when the number of the side surfaces of the regular pyramid is 3, two sensor planes may be mounted on each side surface. It may be obtained from FIG. 1 that the azimuth angles of the six sensor mounting planes are respectively [symbol] , [symbol] and [symbol] . Similarly, when the number of the side surfaces of the regular pyramid is 6, three sensor planes may be mounted on the side surface of the regular pyramid, such that the azimuth angles of the three sensor mounting planes are respectively [symbol] and [symbol] . It may be obtained that the azimuth angle of the unit normal vector nᵢ of the mounting plane of the sensor Pᵢ may be represented as formula [symbol] , wherein α₀ is the azimuth angle of the unit normal vector n₀ of the mounting plane of the sensor P₀. Therefore, it may be deduced from the formula (2):

$${x}_{i} = ( \vert r \vert cos γ cos \text{?} cos ( 2 π \text{?} M + {α}_{0} - {α}_{s} ) + \vert r \vert sin β sin γ ) , \\ \text{?} \text{indicates text missing or illegible when filed} \qquad ( 3 )$$

wherein [symbol] and [symbol] are made, there is

$$\text{?} = \text{?} ( 2 π i \text{/} M + {α}_{0} - {α}_{s} ) + \text{?} , \\ \text{?} \text{indicates text missing or illegible when filed} \qquad ( 4 )$$

xᵢ is arranged in sequence according to the number of the azimuth angles of the unit normal vectors of the sensor mounting planes increasingly to form an orientation sequence x(n). From the formula (4), the orientation sequence is obtained:

$$x ( n ) = \text{?} ( 2 π n \text{/} M + {α}_{0} - {α}_{s} ) + \text{?} 0 \leq n \leq M - 1 , \\ \text{?} \text{indicates text missing or illegible when filed} \qquad ( 5 )$$

wherein Fourier transform or frequency spectrum [symbol] of the orientation sequence x(n) are set as formula, and it may be obtained from discrete Fourier transformation:

$$X ( \text{?} ) = {\sum }_{n = 0}^{M - 1} x ( \text{?} ) \text{?} , \\ \text{?} \text{indicates text missing or illegible when filed} \qquad ( 6 )$$

as a result of [symbol] , it may be deduced from the formula (6):

$$X ( \text{?} ) = \frac{\text{?}}{\text{?}} ( \text{?} G ( \text{?} ) + \text{?} G ( \text{?} ) ) + G ( \text{?} ) , \\ \text{?} \text{indicates text missing or illegible when filed} \qquad ( 7 )$$

wherein,

$$G \text{?} = \text{?} \frac{\text{?}}{\text{?}}$$

$$\text{?} \text{indicates text missing or illegible when filed}$$

[symbol] and [symbol] are input in the formula (7), there is

$$X ( \text{?} ) = \frac{\text{?}}{\text{?}} \text{?} = \frac{\text{?}}{\text{?}} M \vert r \vert cos γ cos β \text{?} , \\ \text{?} \text{indicates text missing or illegible when filed} \qquad ( 9 )$$

wherein X( [symbol] ) is a frequency spectrum component of the orientation sequence [symbol] at an angular frequency 0, and [symbol] is the frequency spectrum component of the sequence at fundamental angular frequency [symbol] and [symbol] . As the fundamental angular frequency of the orientation sequence changes along with the number of the sensors M, the fundamental angular frequency of the orientation sequence changes along with the number of the sensors.

According to formula (9), formula is the azimuth angle of the vector of the radiation source, i.e., the azimuth angle of the radiation source, which may be obtained from a phase of the orientation sequence at two angular frequency [symbol] and [symbol] , and its value is

$${α}_{s} = {α}_{0} \text{?} , \\ \text{?} \text{indicates text missing or illegible when filed} \qquad ( 10 )$$

as a result of [symbol] is made. Therefore, the elevating angle of the vector of the radiation source can be deduced through the formula (8) and formula (9), that is, the elevating angle of the radiation source is:

$$γ = arctan \frac{\text{?}}{\text{?}} ( \vert X ( \text{?} ) \vert / \vert X ( \text{?} ) \vert ) , \\ \text{?} \text{indicates text missing or illegible when filed} \qquad ( 11 )$$

As the geometric construction of the regular pyramid is known, the azimuth angle α₀ and the elevating angle β of the unit normal vector of the mounting plane of the sensor P₀ are all known. It may be known from the formula (10) and formula (11) that the orientation sequence is formed by irradiance radiated to the side surfaces of the regular pyramid, and the azimuth angle αₛ and the elevating angle γ of the radiation source may be solved through the frequency spectrum components of the orientation sequence at the angular frequency 0 and [symbol] .

Usually, there is a ratio coefficient between the irradiance of the radiation source irradiated to the sensor mounting plane and its measuring value is not equal to 1, and we define it as a conversion coefficient, for example, a ratio between the output power of a solar battery and energy incident to the surface of the solar battery. Assuming that the conversion coefficient measured by irradiance is a constant η (η>0), the measured value of the irradiance of the radiation source incident to the plane vertically is [symbol] . It may be known from (8), (9) and (11) that the azimuth angle and the elevating angle of the radiation source are independent of the conversion coefficient. It may be known that the azimuth angle αₛ and the elevating angle γ of the radiation source may be solved by measuring the irradiance of the radiation source incident to the sensor mounting plane.

As a portion, the geometrical relationships between the side surfaces of a regular pyramid the vector of the radiation source are same as that between the side surfaces of its frustum and the vector of the radiation source. It may be known that the azimuth angle αₛ and the elevating angle γ of the radiation source may further be solved by adopting the regular prismoid according to the orientation method.

According to the implementation principle of the orientation method, as long as a discrete sequence formed by irradiance of the radiation source irradiated to the sensor mounting plane is a cosine (or sine) sequence or an overlaying sequence of cosine (or sine) and constant, the radiation source may be oriented by the method.

1. A method for orientating a radiation source based on irradiance, the method comprising the following steps:
accepting irradiation of the radiation source on M side surfaces of a regular pyramid or a regular prismoid and measuring irradiance of the M side surfaces;
sequencing the irradiance of the M side surfaces to obtain an orientation sequence;
performing Fourier transform on the orientation sequence to obtain a coefficient of each of frequency spectrum component Fourier series; and
obtaining an azimuth angle αₛ and an elevating angle γ of the radiation source according to a frequency spectrum component of the orientation sequence with the angular frequency of 0 and ±2π/M,
wherein M is an integer and M≥3; and in the M side surfaces, unit normal vector azimuth angles of adjacent side surfaces differ from each other at an integer multiple of 2π/M.

2. The method for orientating a radiation source based on irradiance according to claim 1, wherein the radiation source is a light source.

3. The method for orientating a radiation source based on irradiance according to claim 2, wherein the light source is the sun.

4. The method for orientating a radiation source based on irradiance according to claim 2, wherein the radiation source is a voltage or a current output by a photoelectric sensor.

5. The method for orientating a radiation source based on irradiance according to claim 1, wherein the radiation source is a microwave emission source.

6. The method for orientating a radiation source based on irradiance according to claim 5, wherein the radiation source is a voltage or a current output by a Hall sensor.

7. The method for orientating a radiation source based on irradiance according to claim 1, wherein the sequencing the irradiance of the M side surfaces to obtain an orientation sequence specifically comprises:
sequencing the irradiance of the M side surfaces to obtain the orientation sequence according to a dimension of an azimuth angle αᵢ of each of unit normal vectors nᵢ of the M side surfaces,
wherein nᵢ is the unit normal vector of the ith side surface, αᵢ is the azimuth angle of nᵢ, and is equal to 0, 1, to (M−1).

8. The method for orientating a radiation source based on irradiance according to claim 7, wherein the angular frequency is [symbol] or [symbol] .

9. The method for orientating a radiation source based on irradiance according to claim 8, wherein an expression formula of the azimuth angle αₛ is [symbol]
, wherein α₀ is the azimuth angle of the unit normal vector n₀, and [symbol] is a frequency spectrum component of the orientation sequence at the angular frequency [symbol] and [symbol] ;
an expression formula of the elevating angle γ is as follows:
$$γ = arctan \frac{\text{?}}{\text{?}} ( \vert X ( \text{?} ) \vert / \vert X ( \text{?} ) \vert ) , \\ \text{?} \text{indicates text missing or illegible when filed}$$
wherein [symbol] is the frequency spectrum component of the orientation sequence at the angular frequency of 0.
